(19) United States
(12) Patent Application Publication
(10) Pub. No.: US 2012/0127567 A1
(43) Pub. Date: May 24, 2012

(54) OBJECTIVE WITH TWO VIEWING DIRECTIONS FOR AN ENDOSCOPE

(75) Inventors: Peter Schouwink, Hamburg (DE); Takayuki Kato, Hamburg (DE)

(73) Assignee: OLYMPUS WINTER & IBE GMBH, Hamburg (DE)

(21) Appl. No.: 13/319,208

(22) PCT Filed: May 4, 2010
(86) PCT No.: PCT/EP10/02717

§ 371 Date: Jan. 9, 2012

(30) Foreign Application Priority Data
May 7, 2009 (DE) 10 2009 020 262.5
Dec. 17, 2009 (DE) 10 2009 059 004.8

(51) Int. Cl. G02B 23/02

(52) U.S. Cl. 359/372

(57) ABSTRACT

The invention pertains to an objective with two viewing directions for an endoscope, with a first distal objective part aligned with its axis in the first viewing direction, a second objective part aligned with its axis in the second viewing direction, and with a proximal objective part directed with its axis on an image sensor or an image guide, as well as a switching device having a prism for switchably deflecting the light path from the first or second distal objective part into the proximal objective part, wherein the switching device includes a ray switching device that can be brought mechanically into the light path.

### CROSS-REFERENCE TO RELATED APPLICATION

The present application is based upon and claims the benefit of priority from PCT/EP2010/002717 filed on May 4, 2010, which claims benefit to DE 10 2009 020 262.5 filed on May 7, 2009 and DE 10 2009 059 004.8 filed on Dec. 17, 2009, the entire contents of each of which are incorporated herein by reference.

### BACKGROUND

1. Field

The present invention generally relates to an objective with two viewing directions for an endoscope, and particularly to an objective of the type described in claim 1.

2. Prior Art

An objective of the same class in accordance with the invention is known from EP 0 363 118 B1. This shows an endoscope objective with two distal objective parts for two different viewing directions and with a common proximal objective part. Electrically controllable polarization filters are provided as switching devices. The brightness of this design is inadequate.

EP 0 347 140 B1 shows an objective with two viewing directions, wherein it is possible to switch between these mechanically by turning the image guide relative to the objective. As is apparent, the manufacturing cost of this design is enormous.

The goal of the present invention consists of, in an objective of the class indicated, to make it possible to switch the viewing direction in a simple manner and with good image brightness.

### SUMMARY

According to the invention, a ray switching device can be mechanically introduced into the light path for switching. In this way the drawbacks of the two designs mentioned initially can be avoided. It is only necessary to move one optical component, and the optical drawbacks of polarization filters are avoided.

Preferably according to claim 2 the optical path length through the objective is the same in both directions. As a result, the optical conditions are simplified.

In objectives of the type in question here, a strongly negatively refracting lens is located at the distal end of each of the two distal objective parts; this creates large imaging errors. These are corrected in the proximal part of the objective, which must therefore be adapted to the distal objective part for correction. The features of claim 3 are advantageously provided for this. In the case of light paths in the two distal objective parts that are identical except for possible reflections, it is guaranteed that both of the distal objective parts are correctly compensated in terms of imaging errors by the corrective measures in the proximal objective part.

Advantageously, according to claim 4, the boundary surface of a prism is switched to be alternately reflecting or transparent. For this purpose a mirror arranged in parallel to the boundary surface is used, which can be moved into or out of the light path and thus either accomplishes the desired reflection or, in its absence, allows the light path to pass through the boundary surface. This results in a very simply designed solution with good image brightness.

The features of claim 5 are advantageously provided. These make it possible to ensure that only the switchable mirror determines whether or not reflection takes place at the boundary surface.

The surfaces of the first gap are generally oblique to the objective axis. As a result, a slight parallel shift of the light path takes place, leading to a slight change in the viewing direction.

Therefore the features of claim 6 are advantageously provided. A second gap with the opposite direction of inclination compensates for the parallel shift of the first gap, so that the resulting viewing direction of the objective, as desired, is straight ahead.

The features of claim 7 are advantageously provided. This results in a design of the prism in which the exit surface toward the proximal objective part is transparent in the area in which the light path is to emerge toward the proximal objective part, but beside that area is made to be internally reflective so that the deflection of the light path for a second viewing direction can take place there.

The reflective design according to claim 7 can be achieved, for example, by a reflective coating of the exit surface in this area or advantageously, according to claim 8, in that the reflecting area is designed to be totally reflective. For this purpose the refractive index of the prism and the reflection angle must be selected correspondingly.

The mirror should be as close to the boundary surface as possible so that nothing that would cause problems can get between them. Then, however, there is a risk of interferences. The gap between the mirror and the boundary surface therefore must not be too narrow. Advantageously according to claim 9 it should amount to more than 1 μm and especially advantageously according to claim 10, greater than 5 μm.

The mirror used for switching between the viewing directions according to claim 1 is advantageously designed in a structural unit with a nearby diaphragm, so that when the mirror is moved out of the light path, the diaphragm is brought into the light path. Then with this diaphragm the light path travelling in the first, straight-ahead viewing direction is limited, which leads to a distinct simplification of the design.

The ray deflection device can also be made in a completely different way, e.g., as a mirror or as an additional prism, and is advantageously designed according to claim 12. In this case the prism has two areas that can be alternately brought into the light path and give different deflections, adapted to the two distal objective parts. For switching it is only necessary to move the prism to the extent that it enters the light path with its first or second area. In a preferred exemplified embodiment the prism can be designed as a flat plate in one area and allows the light path to pass straight through, while it is designed as an actual prism in the other area.

Claim 13 shows an advantageous design for an objective in which the first objective part is designed for viewing straight ahead in the direction of the axis of the proximal objective part. Here the first area of the prism is designed with parallel face surfaces as a flat plate which allows the light path of the first distal objective part to pass through without affecting it.

The mechanical movement of the prism can take place in various ways, for example by rotation of the light, but is advantageously designed according to claim 14, and specifically as a shift transverse to the axis of the proximal objective part.

According to claim 15 one or both of the distal objective parts can be connected to the prism to be moved jointly. In this way for example the design can be improved in terms of optical adjustment, and different design possibilities arise, also regarding the space requirement in the constricted interior space of the endoscope.

### BRIEF DESCRIPTION OF THE DRAWINGS

The invention is illustrated by way of an example and represented schematically in the drawings, in which:

FIG. 1 illustrates a side view of an objective according to the invention in a first design in the switching position of the oblique viewing direction,

FIG. 2 illustrates a front view according to FIG. 1 in the switching position of the straight-ahead viewing direction.

FIG. 3 illustrates a top view of the mirror visible in FIGS. 1 and 2 in a variant embodiment with adjacent diaphragm,

FIG. 4 illustrates a highly schematic representation of an objective according to the invention in a second embodiment in a first switching position, and

FIG. 5 illustrates the objective of FIG. 4 in its second switching position.

### DETAILED DESCRIPTION

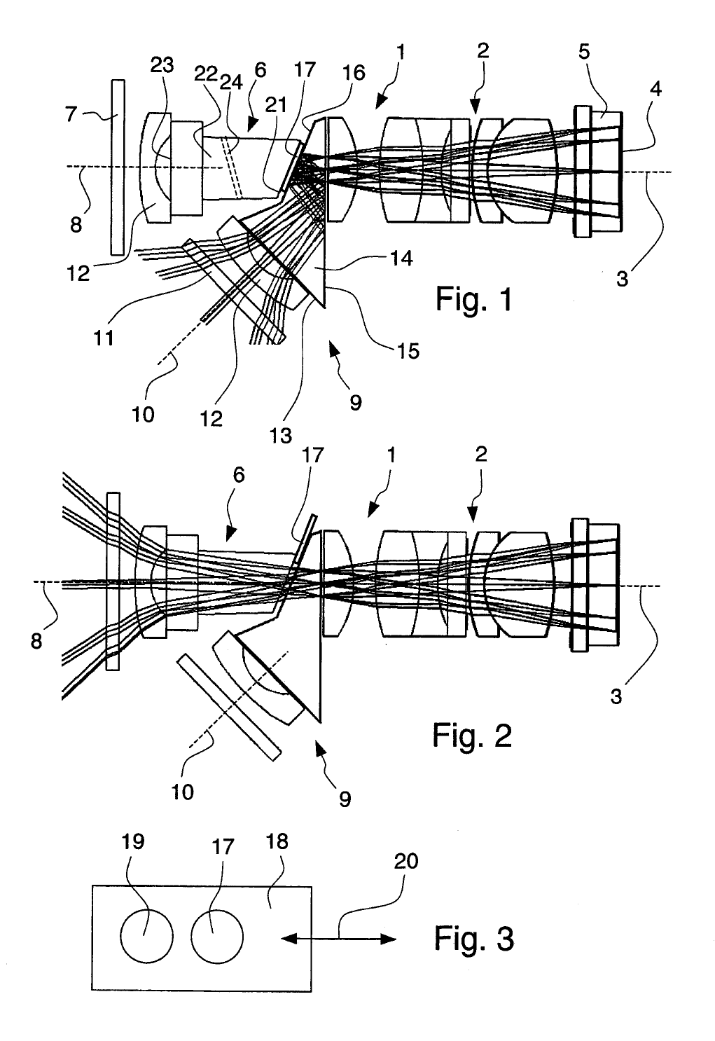

FIG. 1 shows an objective 1 according to the invention in a first embodiment that consists of three objective parts.

A proximal objective part 2 is arranged with its axis 3 in the axis of the shaft (not shown) of an endoscope, in the distal end area of which the objective 1 is disposed. The proximal objective part 2 consists of several lenses and, together with one of two distal objective parts, generates an image through a glass plate 5 in an image plane 4, which for example may have an electronic image sensor. The image plane 4 may also be an intermediate image plane, from which a customary image guide, for example an image guide with a relay lens arrangement, transfers the image to an eyepiece positioned proximally on the endoscope.

In the distal area of the objective 1, a first distal objective part 6 is disposed, which looks straight ahead through a window 7 of the endoscope, otherwise not shown, with its axis 8 parallel to the axis 3 of the proximal objective part, thus in the direction of the axis of the endoscope. Furthermore, a second distal objective part 9 is provided, which looks with its axis 10 in a second, oblique viewing direction through a window 11.

The second distal objective part 9 on its distal end has a negative refracting lens 12, which sits on an entry surface 13 of a prism 14. The light path shown in FIG. 1, falling from the inclined viewing direction of the axis 10, is reflected on an exit surface 15 of the prism 14 located perpendicular to the axis 3 of the proximal objective part and is cast onto a boundary surface 16 of the prism 14, from which after a further reflection, the light path is brought into the direction of the axis 3 of the proximal objective part 2, to emerge through the exit surface 15 of the prism 14 into the proximal objective part 2, where its image is formed in the image plane 4 with the light path shown.

The light path shown in FIG. 1, entering in the direction of the axis 10 in the oblique viewing direction, is thus internally reflected twice within the prism 14, once at the exit surface 15 and then at the boundary surface 16. Since no reflection occurs in the first distal objective part 6 and reflection occurs twice in the distal objective part 9, the same image orientation results in both distal objective parts, e.g., in both cases an upright image or in both cases an upside-down image.

In the reflecting area of the exit surface 15 in which the internal reflection must take place, the exit surface 15 may be, for example, mirror-coated from the outside. This mirror coating, however, then must not be extended into the area in which the light path is to pass through after reflection at the boundary surface 16 in the direction toward the proximal objective part 2. An elegant solution to this problem, as shown in FIG. 1, consists of not mirror-coating the exit surface 15, but instead selecting the refractive index of the prism 14 and the reflection angle at the exit surface 15 such that total reflection occurs.

As FIG. 1 shows, the reflection angle for the second reflection, which takes place at the boundary surface 16, is selected to be very acute, so that total reflection cannot occur here. The light rays striking the boundary surface 16 from the inside thus pass through this. The reflection of the light rays at the boundary surface 16, shown in FIG. 1, therefore must be accomplished by other means.

For this purpose, as shown in FIGS. 1 and 2, a mirror 17 adjacent to the boundary surface 16 is provided, which has a mirror coating surface in the direction of the boundary surface 16. FIGS. 1 and 2 show two switching positions of the mirror 17. In the position in FIG. 1, the mirror sits in the light path and brings about the back-reflection of the rays shown in FIG. 1,

FIG. 2 shows the unchanged design of FIG. 1 in the same view, wherein only the switching position of the mirror 17 is altered.

In the position according to FIG. 2, the mirror 17 is shifted to the side. The light path entering obliquely in the direction of the axis 10 through the second distal objective part 9 is no longer reflected internally at the boundary surface 16 in the direction of the proximal objective part 2, but emerges through the boundary surface 16 and escapes into space. The light path shown in FIG. 2, entering through the first distal objective part 6, looking straight ahead in the direction of its axis 8, which is captured in mirror position 17 according to FIG. 1 by the back part of said mirror, can now, the mirror having been pushed aside in the switching position according to FIG. 2, enter the prism through the boundary surface 16 and proceed straight ahead in the direction of the axis 8 through the exit surface 15 to the proximal objective part 2, as is shown in FIG. 2.

If the mirror 17 is moved from the position according to FIG. 2 back into the light path to the position according to FIG. 1, once again the blocking of the light path entering through the first distal objective part 6 occurs and once again the course of the ray shown in FIG. 1 takes place. Since total reflection does not occur at the boundary surface 16, the reflection at this point is determined solely by the switching position of the mirror 17 and thus can be controlled systematically.

In the embodiment of FIGS. 1 and 2 the mirror 17 is designed as a simple, flat mirror, which is movable, sliding on the boundary surface 16 of the prism 14 between the two switching positions of FIGS. 1 and 2, specifically with a movement direction in the plane of the drawing.

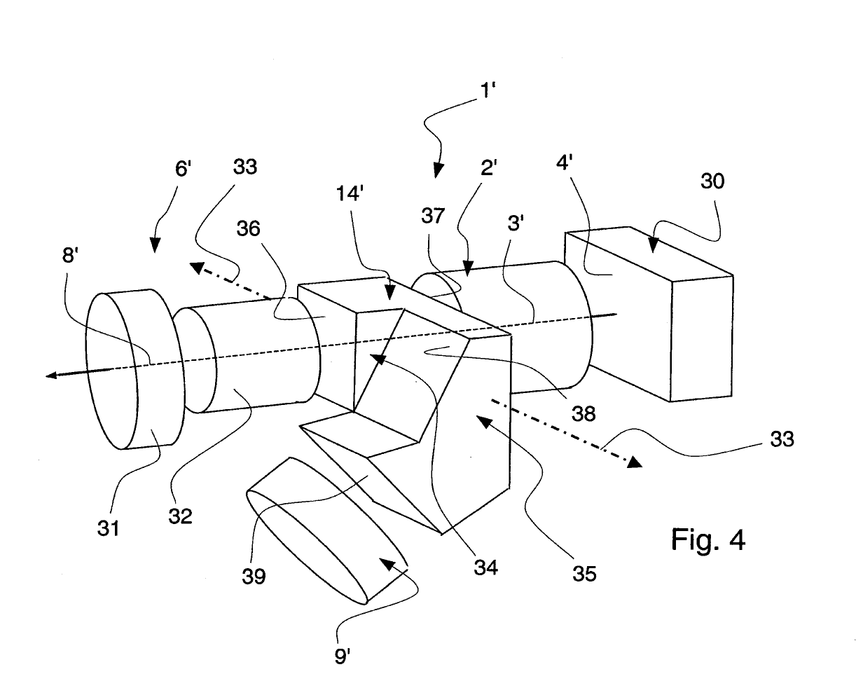

However, the mirror 17 could also be moved in the direction perpendicular to the plane of the drawing. Then, as shown in FIG. 3, it could be disposed in a sliding plate 18 in a structural unit with a diaphragm 19. By moving the sliding plate 18 in the direction of the arrow 20, therefore, optionally either the mirror 17 or the diaphragm 19, formed as a hole in the sliding plate 18, can be moved into the light path.

When the sliding plate 18 of FIG. 3 is used, the light path shown in FIG. 1 can be generated if the sliding plate 18 is moved such that the mirror 17 is located in the light path, thus in the position according to FIG. 1. After sliding the slide plate 18 until the diaphragm 19 is in the light path, the result is the light path according to FIG. 2, which is now limited by the diaphragm 19 in the desired manner.

The mirror 17, either as a single component or as a structural unit according to FIG. 3, is arranged in the direction of the boundary surface 16, movable on this. In this case the mirror is located in a gap between the boundary surface 16 and the exit surface 21 of a glass rod 22 arranged in parallel to this, which as shown in FIG. 1 carries an additional, negatively refracting lens 12 on its proximal entry surface 23.

The first gap, formed between the boundary surface 16 and the exit surface 21 of the glass rod 22, like any gap between parallel surfaces, upon passage of light results in a parallel displacement of the light path. This leads to a slight shift in the viewing direction, thus a slight tipping of the straight-ahead viewing direction.

To avoid this, a second gap 24 is shown with broken lines in FIG. 1, produced at this point by separating and pulling apart two parts of the glass rod 22. The second gap 24 is arranged at an angle to the axis 8 which amounts to 180°0 minus the angle of the first gap. Like the first gap, the second gap 24 causes a parallel shift of the light path, but in the opposite direction from the first gap, so that the two shifts cancel one another.

At least when it is located in the switching position of FIG. 1 and is placed in the light path, the mirror 17 should be close to the boundary surface 16 so that little air or even dust can enter between these surfaces in an interfering way. Then, however, the risk of interferences between the two closely adjacent opposing surfaces exists. The gap between the mirror 17 and the boundary surface 16 thus must not be too narrow. In any case it must be greater than 1 μm and preferably greater than 5 μm.

As a comparison of FIGS. 1 and 2 shows, the light paths in the two distal objective parts 6 and 9 are formed identically except for the fact that a double reflection takes place in the second distal objective part 9, as a result of which the light path is formed in the manner shown in FIG. 1. As a result, the same image orientation occurs in both cases. If the image formed in image plane 4 is upright in the case of the image formation in FIG. 1, it is upright in the case of the image formation in FIG. 2.

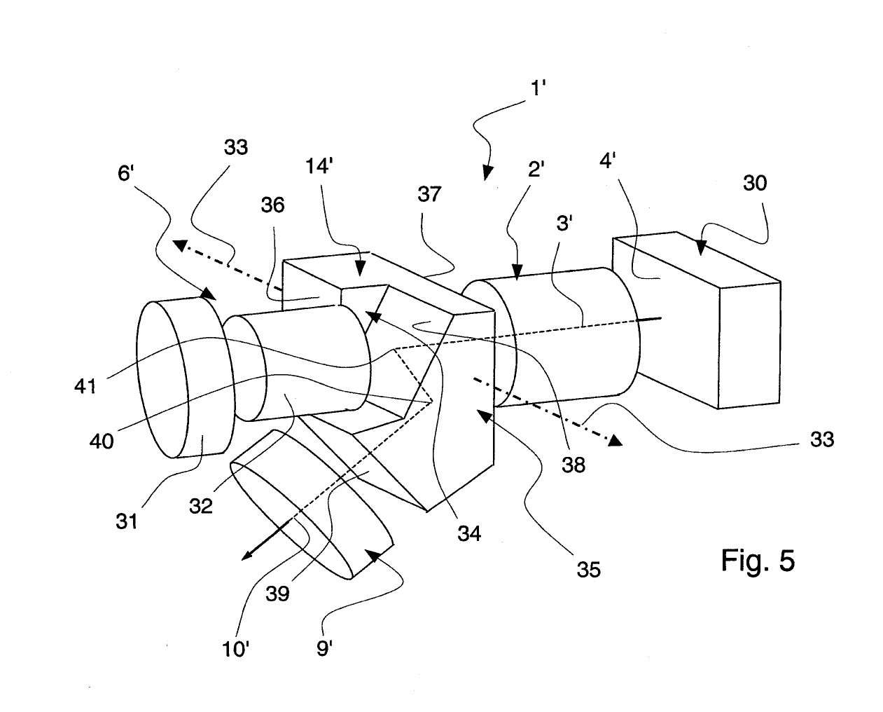

FIGS. 4 and 5 show an objective 1′ in a second embodiment. The objective 1′ provided for installation in the distal end region of an endoscope shaft, not shown, is illustrated in a highly schematic representation of its essential components.

A proximal objective part 2′ is aligned with its axis 3′ on an image plane 4′ which in the illustrated exemplified embodiment is the light-sensitive plane of an electronic image sensor 30. This is connected in a manner not shown, over electrical lines, to the image processing devices. Instead of the image plane 4′ of the image sensor 30, the distal end surface of an image guide fiber bundle may be provided, with which the image is transported over the length of the endoscope.

The objective has two distal objective parts for different viewing directions. A first distal objective part 6′ in the highly schematized illustrated exemplified embodiment consists of a lens part 31 and a planar plate 32, which is passed through by the axis 8′ of the first distal objective part 6′ perpendicular to the plane-parallel faces.

As is apparent from FIG. 4, the axis 8′ of the first distal object part 6′ coincides with axis 3′ of the proximal objective part 2′. In the conventional construction mode, this axis is located parallel to the longitudinal axis of the endoscope shaft, so that this first distal objective part 6′ looks straight ahead.

Between the proximal objective part 2′ and the first distal objective part 6′ in the direction of the optical axis is an interval in which a prism 14′ is disposed. Transverse to the axis 3′ of the proximal objective part 2′, the prism 14′ can be moved in the direction of the double arrow 33. For this purpose, for example, a sled, not shown, is provided, which is disposed in the housing, not shown, or the holder of the objective 1′. The propulsion for moving this can take place by manual actuation or for example with an electric motor.

Falling one behind another in the direction of the double arrow 33, the prism 14′ has two areas, specifically a first area 34 and a second area 35.

The first area 34 of the prism 14′ is designed as a planar plate. A distal planar surface 36 and a proximal planar surface 37 are located perpendicular to the axis 3′ of the proximal objective 2′.

In the representation of FIG. 4 the prism 14′ is located in a sliding position in which the light path coming from the first distal objective part 6′ travels through the plane-parallel first region 34 of the prism 14 on its path to the proximal objective part 2′.

The second region 35 of the prism 14′ has the same proximal planar surface 37 passing through it as the first region 34. Distally, however, it has oblique surfaces, specifically a reflection surface 38 for internal reflection and an exit surface 39 in front of which a distal objective portion 9′ is arranged.

FIG. 5 shows the objective 1′ in a position in which the prism 14′ is switched into another position, specifically such that the second area 35 of the prism 14′ is located distally in front of a proximal objective part 2′. The ray axis shown in FIG. 5 travels from the axis 10′ of the second distal objective part 9′ after reflection at 40 on the proximal planar surface 37 of the prism 14′, and after reflection at 41 on the distal oblique surface 38, into the axis 3′ of the proximal objective part 2′. The internal reflection points at 40 and 41 can both be made totally reflecting in the exemplified embodiments.

In the position of FIG. 5, the image sensor 30 thus looks through the second distal objective part 9′ at an oblique angle while in the position of FIG. 4 it looks straight ahead through the first distal objective part 6′.

As comparison of FIGS. 4 and 5 shows, the second proximal objective part 9′ is connected to the prism 14′ for joint movement. The connection means for this are not shown in the drawing. The other component groups 6′, 2′ and 30 are once again fastened together, as comparison of FIGS. 4 and 5 shows.

In a modified embodiment, not shown, for example the second distal objective part 9′ may stand permanently in the position of FIG. 5 and be permanently connected to the components 6′, 12′ and 30, while the prism 14′ can be moved in the direction of the double arrow 33 independently of all other components. In an alternative design, both distal objective parts 6′ and 9′ can be connected to the prism 14′ for joint movement. In this way, design variation possibilities exist, each of which has its own advantages, for example for construction reasons or for reasons of space.

As can be seen from the comparison of FIGS. 4 and 5, in the objective 1′ shown, care is taken that the optical path length, also called “optical distance” or “light path,” is the same in both viewing directions. Comparison of FIGS. 4 and 5 specifically shows that the optical path length through the prism area 35 of the prism 14′ is substantially longer than that through the planar plate area 34. However, this is compensated by the light path through the planar plate 32 shown in FIG. 4, which can be of dimensions such that the optical path length is actually the same in both ray paths of FIGS. 4 and 5.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. An objective with first and second viewing directions for an endoscope, the objective comprising:
a first distal objective part aligned with its axis in the first viewing direction,
a second objective part aligned with its axis in the second viewing direction, and
a proximal objective part directed with its axis on one of an image sensor or an image guide, as well as a switching device having a prism for switchably deflecting the light path from the first or second distal objective part into the proximal objective part,
wherein the switching device includes a ray switching device that can be brought mechanically into the light path.

2. The objective according to claim 1, wherein the optical path length through the objective is the same in the first and second viewing directions.

3. The objective according to claim 1, wherein light paths into the first and second distal objective parts are identical except for necessary reflections.

4. The objective according to claim 1, wherein the prism receives light paths of the first and second distal objective parts and directs them, combined, into the proximal objective part and has a boundary surface traveling oblique to the axis of the proximal objective part, wherein the light path of the first distal objective part enters through the boundary surface into the prism and the light path of the second distal objective part is reflected back into the prism by reflection in the area of the boundary surface, to enter the proximal objective part, and wherein a movable mirror is provided in the area of the boundary surface, which by its movement selectively frees up the passage through the boundary surface or causes reflection at the boundary surface.

5. The objective according to claim 4, wherein the prism is configured such that total reflection does not take place at the boundary surface.

6. The objective according to claim 4, wherein a glass rod of the first distal objective part has an exit surface extending at a distance from a first gap in parallel to the boundary surface, and that the glass rod is divided by a second gap which falls at an angle to the axis of the first distal objective part that amounts to 180° minus the angle of the first gap.

7. The objective according to claim 6, wherein the prism is made to be internally reflective on its exit surface lying toward the proximal objective part adjacent to the exit surface.

8. The objective according to claim 7, wherein the prism is made totally reflecting in the reflecting area of the exit surface.

9. The objective according to claim 4, wherein the distance between the mirror and the boundary surface is greater than 1 μm.

10. The objective according to claim 9, wherein the distance is greater than 5 μm.

11. The objective according to claim 4, wherein the mirror with a diaphragm arranged adjacent to it forms a component arranged movably in parallel to the boundary surface.

12. The objective according to claim 1, wherein the prism has two areas that can be brought alternately into the light path, a first area of which guides the light path from the first distal objective part and a second area guides the light path from the second distal objective part into the proximal objective part.

13. The objective according to claim 12, wherein the proximal objective part and the first distal objective part are arranged on the same axis and the prism is arranged between the proximal objective part and the first distal objective part, wherein the first area of the prism is formed as a planar plate, while the second area deflects at an angle that corresponds to the angle between the second viewing direction and the axis of the proximal objective part.

14. The objective according to claim 12, wherein the prism is movable transverse to the axis of the proximal objective part, and is arranged between the latter and the distal objective part.

15. The objective according to claim 12, wherein at least one of the first and second distal objective parts is fastened on the prism for joint movement.
